(19) United States
(12) Patent Application Publication
(10) Pub. No.: US 2014/0347355 A1
(43) Pub. Date: Nov. 27, 2014

(54) RAY TRACING CORE AND METHOD FOR PROCESSING RAY TRACING

(71) Applicant: SILICONARTS INC., Seoul (KR)

(72) Inventor: Hyung-min YOON, Seoul (KR)

(21) Appl. No.: 14/456,055

(22) Filed: Aug. 11, 2014

Related U.S. Application Data
(63) Continuation-in-part of application No. 13/985,125, filed on Aug. 13, 2013, now Pat. No. 8,836,702.

(30) Foreign Application Priority Data
Feb. 14, 2011 (KR) 10-2011-0012860

(51) Int. Cl. G06T 15/06

(52) U.S. Cl. CPC G06T 15/06; G06T 2200/04
USPC 345/419

(57) ABSTRACT

A ray tracing core comprises a ray tracing unit (RTU), a control unit, and a tree build unit (TBU). The tree build unit (TBU) builds one selected of a plurality of spatial expression data structures. The ray tracing unit (RTU) performs ray tracing based on the spatial expression data structure which is selected. The control unit selects one of a plurality of spatial expression data by calculating an execution complexity of the ray tracing unit and the tree build unit.

### CROSS REFERENCE TO RELATED APPLICATIONS

This is a continuation-in-part application of U.S. patent application Ser. No. 13/985,125, filed on Aug. 13, 2013, which is a national entry of International Application No. PCT/KR2011/001083, filed on Feb. 18, 2011, which claims a priority to and the benefit of Korean Patent Application No. 10-2011-0012860, filed on Feb. 14, 2011, the contents of which in their entirety are herein incorporated by reference.

### TECHNICAL FIELD

This closure relates to three-dimensional graphic processing, and more particularly to a ray tracing core and a method for processing ray tracing.

### BACKGROUND ART

A three-dimensional graphic technology is a graphic technology using a three-dimensional expression of geometric data stored in a computer, and has been extensively used for various industries such as a media industry and a game industry. In general, the three-dimensional requires a high performance graphic processor due to a large amount of computation.

In recent years, with the development of a processor, researches and studies have been performed toward a ray tracing technology capable of creating a realistic three-dimensional graphic.

The ray tracing technology is a rendering scheme according to global illumination, and may generate a realistic 3D image because reflection, refraction, shadow effect are naturally provided in consideration of an influence of light reflected and refracted from another object.

### TECHNICAL SOLUTION

According to the embodiment, there is provided a ray tracing core including a ray tracing unit (RTU), a control unit, and a tree build unit (TBU). The tree build unit (TBU) builds one selected of a plurality of spatial expression data structures expressing a specific space. The ray tracing unit (RTU) performs ray tracing based on the selected spatial expression data structure. The control unit to select one of a plurality of spatial expression data by calculating an execution complexity of the ray tracing unit and the tree build unit. In one embodiment, the ray tracing unit may perform ray tracing based on a special partitioning structure. The control unit may calculate the complexity of the spatial partitioning structure by monitoring the load state of the ray tracing unit. The tree build unit may build the spatial partitioning structure having the calculated complexity. In one embodiment, the load state may be determined based on a frame rate being processed in the pertinent unit. In another embodiment, one of the plurality of the spatial expression data structures may apply a bounding volume Hierarchy (BVH) a K-dimensional (KD) tree corresponding to a spatial partitioning structure. For example, the execution complexity may be modified according to either the maximum primitive number of a leaf node with respect to a K-dimensional tree structure and/or a tree depth. In the embodiment, one of the plurality of the spatial expression data structures may be a Mean tree corresponding to a number partitioning structure. In one embodiment, the ray tracing core may further include a primitive cache to provide a primitive scene to the tree build unit and an acceleration structure result buffer to receive a processing result with respect to the primitive scene from the tree build unit. In another embodiment, the ray tracing core may further include an acceleration structure cache to provide tree build information with respect to a primitive scene processed by the tree build unit to the ray tracing unit a texture cache to provide a texture to the ray tracing unit and a color result buffer to receive the tree build information and a processing result with respect to the texture from the ray tracing unit. In one embodiment, the control unit selects one of the plurality of the spatial expression data structures being applied to an image next to the specific image to reduce or maintain the the execution complexity by comparing the the execution complexity of the ray tracing unit and the tree build unit performed based on the selected spatial expression data structure with respect to a specific image with a predetermined criterion.

According to the embodiment, there is provided a method for processing ray tracing by a ray tracing processing apparatus, the method calculating an execution complexity of a ray tracing unit (RTU) and a tree build unit (TBU), modifying a spatial expression data structure to reduce the complexity of the spatial partitioning structure when the execution complexity is larger than a predetermined criterion and maintaining the applied spatial expression data structure when the execution complexity is less than or equal to the predetermined criterion. For example, the tree build unit may build the spatial partitioning structure, the ray tracing unit may perform ray tracing based on the spatial partitioning structure and the tree build unit the execution complexity may convert the spatial partitioning structure into a number partitioning structure. In one embodiment, the method monitors a load state of the ray tracing unit (RTU) and a load state of the tree build unit (TBU), controls for reducing a complexity of the spatial partitioning structure when the load of the ray tracing unit is larger than the load of the tree build unit, controls for increasing the complexity of the spatial partitioning structure when the load of the ray tracing unit is less than the load of the tree build unit and provides the controlled complexity to the tree build unit. For example, the ray tracing unit may perform the ray tracing based on the spatial partitioning structure and the tree build unit may build the spatial partitioning structure. In one embodiment, the method may confirm a frame processing speed of the ray tracing unit, confirm a frame processing speed of the tree build unit, calculate a frame rate per unit time processed by the ray tracing unit and a frame rate per unit time processed by the tree build unit and determine the load state of the ray tracing unit and the load state of the tree build unit based on the calculated frame rate. For example, the spatial partitioning structure may include a bounding volume Hierarchy (BVH) or K-dimensional (KD) tree and the complexity may be modified according to either the maximum primitive number of a leaf node with respect to the BVD or KD tree structure and/or a tree depth. In one embodiment, the method may reduce the complexity of the spatial partitioning structure by increasing the maximum primitive number and/or reducing the tree depth when the load of the ray tracing unit is larger than the load of the tree build unit. In another embodiment, the method may increase the complexity of the spatial partitioning structure by reducing the maximum primitive number and/or increasing the tree depth when the load of the ray tracing unit is less than the load of the tree build unit.

According to the embodiment, there is provided a ray tracing processing apparatus including: a central processing unit (CPU) to execute a three-dimensional application, a system memory to store graphic data information necessary for the three-dimensional application and a dynamic ray tracing accelerator (DRTX) to build one selected of a plurality of spatial expression data structures based on the graphic data information, to perform ray tracing based on the selected spatial expression data structure and to change or maintain the spatial expression data structure with respect to the graphic data information by calculating an execution complexity of the ray tracing. In one embodiment, the DTRC builds a spatial partitioning structure based on the graphic data information, performs ray tracing based on the built spatial partitioning structure, provides a result of the performed ray tracing to the CPU and monitors a ray tracing speed to rebuild the spatial partitioning structure with respect to the graphic data information. For example, the ray tracing processing apparatus may further include an external memory operatively associated with the DRTX, to store an acceleration structure of the spatial partitioning structure built according to the graphic data information necessary for the three-dimensional application and to provide the acceleration structure of the spatial partitioning structure to the DRTX. In one embodiment, the system memory may include a primitive static scene (PSS) area to store static scene information necessary for the three-dimensional application, a primitive dynamic scene (PDS) area to store dynamic scene information necessary for the three-dimensional application and a texture map area to store an MIP-MAP for mapping a texture. In another embodiment, the DRTX may include a ray tracing unit (RTU) to perform ray tracing with respect to a static scene and/or a dynamic scene based on the spatial partitioning structure a control unit to calculate a complexity of the spatial partitioning structure by monitoring a load state of the ray tracing unit and a tree build unit to build the spatial partitioning structure having the calculated complexity with respect to the dynamic scene. For example, the ray tracing processing apparatus may further include an external memory to store an acceleration structure of the spatial partitioning structure built according to a corresponding static scene and/or dynamic scene built in the tree build unit, and to provide the acceleration structure of the spatial partitioning structure to the ray tracing unit.

### DESCRIPTION OF DRAWINGS

FIG. 1 is a block diagram illustrating a ray tracing core according to an embodiment of this disclosure.

FIG. 2 is block diagram illustrating a ray tracing apparatus including the ray tracing core shown in FIG. 1.

FIG. 3 is a flowchart illustrating a method for processing ray tracing performed by FIG. 1.

FIG. 4 is a flowchart illustrating an example of a method for processing ray tracing shown in FIG. 3 in detail.

FIG. 5 is a diagram illustrating the method for processing ray tracing.

FIG. 6 is a diagram illustrating an acceleration structure and geometric data used for this disclosure.

### BEST MODE

### Mode for Invention

The embodiments and the configurations depicted in the drawings are illustrative purposes only and do not represent all technical scopes of the embodiments, so it should be understood that various equivalents and modifications may exist at the time of filing this application. Although a preferred embodiment of the disclosure has been described for illustrative purposes, those skilled in the art will appreciate that various modifications, additions and substitutions are possible, without departing from the scope and spirit of the invention as disclosed in the accompanying claims.

Terms and words used in the specification and the claims shall be interpreted as to be relevant to the technical scope of the invention based on the fact that the inventor may property define the concept of the terms to explain the invention in best ways.

The terms “first” and “second” can be used to refer to various components, but the components may not be limited to the above terms. The terms will be used to discriminate one component from the other component. For instance, the first component may be referred to the second component and vice versa without departing from the right of the disclosure.

The term “and/or” will be used to refer to the combination of plural items or any one item of the plural items. For example, “a first item, a second item, and/or a third item” signify all combinations of at least two of the first item, the second item, and/or the third item as well as the first item, the second item, and/or the third item.

In addition, when a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific embodiments and have no intention to limit the disclosure. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Reference numerals, for example, a, b, c, . . . are used for the purpose of illustration. The reference numerals do not describe an order of respective steps. The respective steps may be performed differently from an expressed order if the context does not describe a specific order. That is, the respective steps may be performed in the same order as the expressed order, may be simultaneously performed and may be performed in an opposite order.

Unless defined otherwise, the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively.

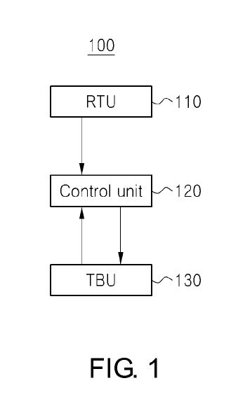

FIG. 1 is a block diagram illustrating a ray tracing core according to an embodiment of this disclosure.

Referring to FIG. 1, the ray tracing core includes a ray tracing unit (RTU) 110, a control unit 120, and a tree build unit (TBU) 130.

The RTU 110 performs ray tracing based on a spatial expression data structure selected from TBU 130. In one embodiment, the RTU 110 may perform the ray tracing based on a special partitioning structure. The method of performing the ray tracing will be described in detail later.

The control unit 120 selects one of a plurality of spatial expression data by calculating an execution complexity of the RTU 110 and TBU 130. In one embodiment, the control unit 120 calculates the complexity of the spatial partitioning structure by monitoring a load state of the RTU 110. For example, the load state may be determined based on a processed frame rate in the RTU 110 and/or the TBU 130.

The TBU 130 builds one selected of a plurality of spatial expression data structures expressing a specific space. Herein, the plurality of the spatial expression data structure may include a bounding volume Hierarchy (BVH) or K-dimensional (KD) tree corresponding to a spatial partitioning structure and a Mean tree corresponding to a number partitioning structure. In one embodiment, the TBU 130 builds the spatial partitioning structure having the calculated complexity. For example, the spatial partitioning structure may apply the BVH or KD- tree. In one embodiment, the complexity may be modified according to either a maximum primitive number of a leaf node with respect to the BVD or KD-tree structure and/or a tree depth when the BVH or KD-tree is applied. The BVD or KD-tree will be described in detail later. For example, if increasing the maximum primitive number of the leaf node or reducing the total tree depth, the quality in an acceleration structure (AS) is degraded but processing speed of the TBU 130 may be improved. Thereby, an efficiency of the ray tracing may be degraded. As another example, if reducing the maximum primitive number of leaf nodes or increasing the total tree depth, the quality in an acceleration structure (AS) is improved, which may result in increase in the performance of the ray tracing but the processing speed of the TBU 130 may be reduced. Accordingly, if the performance of the TBU 130 is degraded, the TBU 130 may control to improve the processing speed of the TBU 130. If the performance of the TBU 130 is sufficient, the TBU 130 may control to improve the quality in the AS.

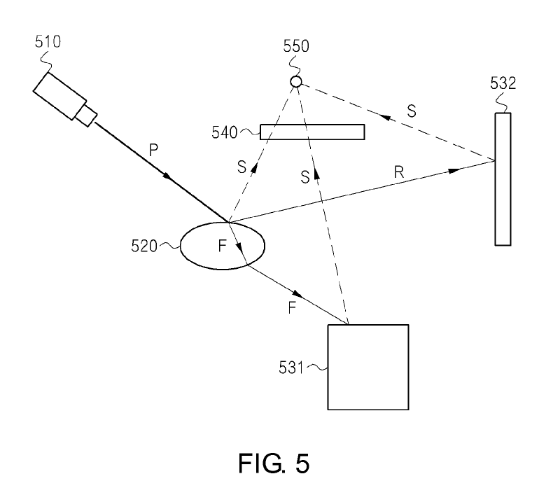

FIG. 5 is a diagram illustrating the method for processing ray tracing.

Referring to FIG. 5, the ray tracing core generates a primary ray P from a position of a camera 510 per pixel to calculate an object 520 meeting with the primary ray P. When an object meeting a corresponding ray P is an object 520 having a refractive property or objects 531 and 532 having a reflective property, a refraction ray F for a refractive effect and/or a reflection ray R for a refractive effect may be generated at a location with which the corresponding ray P and the object meet, and a shadow ray S may be generated in a direction of a light 550. In an embodiment, if the shadow ray S meets with another object 540, a shadow may be generated at a point at which the corresponding shadow ray S is generated.

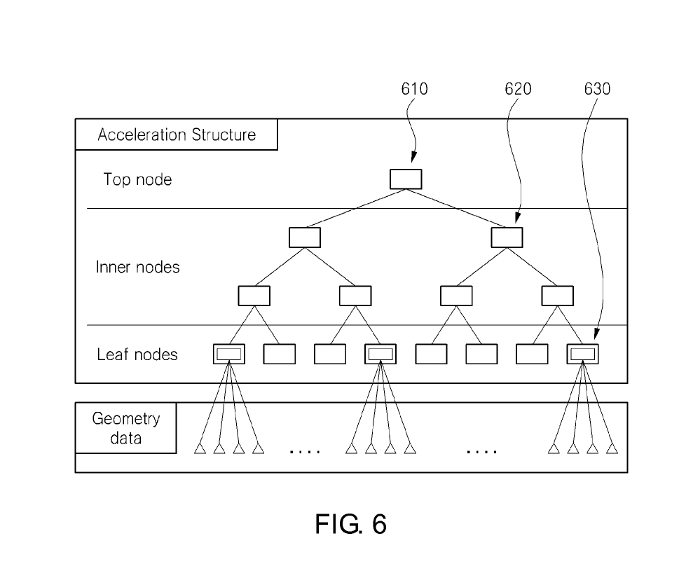

FIG. 6 is a diagram illustrating an acceleration structure and geometric data used for this disclosure.

In FIG. 6, it is assumed that an acceleration structure AS uses a KD-tree. The KD-tree is a type of spatial partitioning structure and may be used for ray-triangle intersection test. For example, the KD-tree may include a box node 610, an inner node 620, and a leaf node 630. For example, the leaf node 630 may include a triangle list for pointing at least one triangle information included in geometric data. For instance, the triangle information may include color coordinates, normal vectors, and/or texture coordinates. For example, when the triangle information included in the geometric data is arranged, the triangle list included in the leaf node may correspond to an arrangement index.

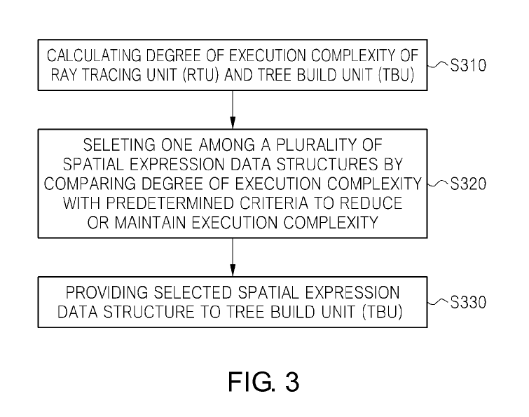

FIG. 3 is a flowchart illustrating a method for processing ray tracing performed by FIG. 1.

Referring to FIG. 3, the control unit 120 may calculate the execution complexity of the RTU 110 and the TBU 130 (Step S310). In one embodiment, the control unit 120 may monitor load states of the RTU 110 and the TBU 130. For example, the RTU 110 may perform the ray tracing based on the special partitioning structure, and the TBU 130 may build the spatial partitioning structure.

The control unit 120 may reduce or maintain the execution complexity by calculating the calculated execution complexity with a predetermined criterion and selecting one of the plurality of the spatial expression data structures (Step S320). When the load of the RTU 110 is larger than the load of the TBU 130, the control unit 120 may control to reduce the complexity of the spatial partitioning structure. In contrast, when the load of the RTU 110 is less than the load of the TBU 130, the control unit 120 may control to increase the complexity of the spatial partitioning structure.

The control unit 120 may provide the selected spatial expression data structure to the TBU 130 (Step S330). The control unit 120 may provide the controlled complexity to the TBU 130. For example, the TBU 130 may reconfigure the spatial partitioning structure corresponding to the controlled complexity provided from the control unit 120.

In one embodiment, the control unit 120 may monitor the load state of the RTU 110 performing the ray tracing based on one selected of the plurality of the spatial expression data structures, calculate the complexity of the selected spatial partitioning structure to provide the calculated complexity to the TBU 130 and build the spatial partitioning structure having the calculated complexity received to the TBU 130. The control unit 120 may calculate the complexity of the selected spatial expression data structure by monitoring the load state of the RTU 110 when the execution complexity of the RTU 110 and the TBU 130 is larger than the predetermined criterion to not provide the calculated execution complexity to the TBU 130 and to perform the ray tracing.

In one embodiment, the control unit 120 may calculate a complexity of the spatial expression data structure selected by the TBU 130 by monitoring the load state of the RTU 110 not to provide and to perform the ray tracing. The control unit 120 may select another one of the plurality of the spatial expression data structures to perform the ray tracing on the pertinent spatial expression data structure or calculate the complexity of the selected spatial expression data structure by monitoring the load state of the RTU 110 to provide the TBU 130 when the execution complexity of the ray tracing unit and the tree build unit performed based on the selected spatial expression data structure is larger than a predetermined criterion.

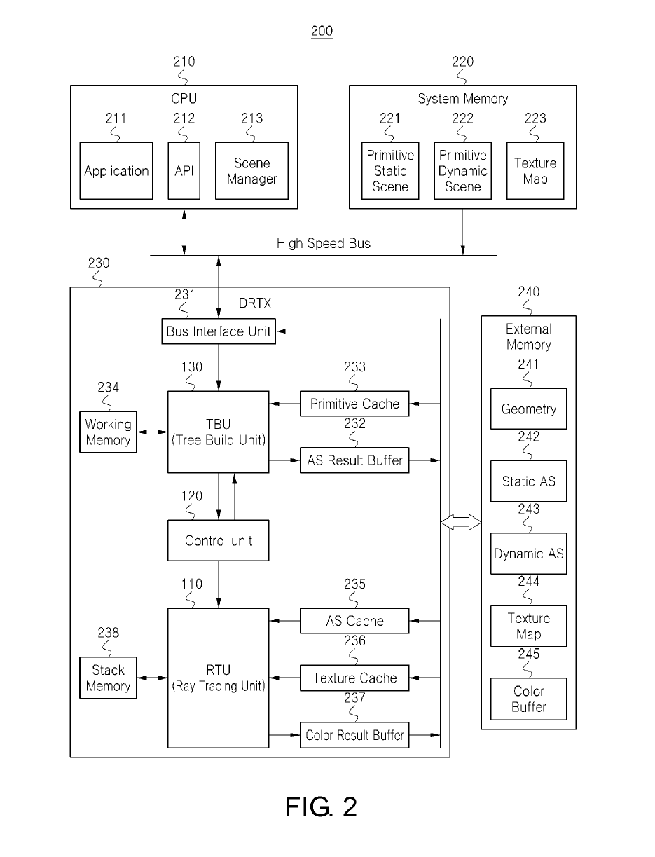

FIG. 2 is block diagram illustrating a ray tracing apparatus including the ray tracing core shown in FIG. 1.

Referring to FIG. 2, the ray tracing apparatus 200 may include a central processing unit (CPU) 210, a system memory 220, a dynamic ray tracing accelerator (DRTX) 230 and an external memory 240.

The CPU 210 may process a three-dimensional application, and may include an application 211 such as a three-dimensional game engine, an application programming interface (API) 212, and/or a scene manager.

The system memory 220 may store graphic data information necessary for the three-dimensional application and may include a primitive static scene (PSS) area 221 to store a PSS, a primitive dynamic scene (PDS) area 222 to store a PDS, and/or a texture map area 223 to store an MIP-MAP for mapping a texture.

The DRTX 230 includes the ray tracing core 100 shown in FIG. 1, and may further include a bus interface unit 231, an AS result buffer 232, a primitive cache 233, a working memory 234, an AS cache 235, a texture cache 236, a color result buffer 237, and/or a stack memory 238. In one embodiment, the DRTX 230 may build one selected of the plurality of the spatial expression data structures based on the graphic data information, perform the ray tracing based on the selected spatial expression data structure, provide a result of the performed ray tracing to the CPU 210 and change or maintain the spatial expression data structure with respect to the graphic data information by calculating the execution complexity of the ray tracing. In another embodiment, the DRTX 230 may build the spatial partitioning structure based on the graphic data information, perform the ray tracing based on the special partitioning structure, provide the result of the performed the ray tracing to the CPU 210, and rebuild the space partitioning structure with respect to the graphic data information by monitoring the ray tracing speed.

The external memory 240 may temporarily store information processed by the DRTX 230, and may include a geometric information storage area 241, a static scene AS storage area 242, a dynamic scene AS storage area 243, a texture map storage area 244, and/or a color information storage area 245.

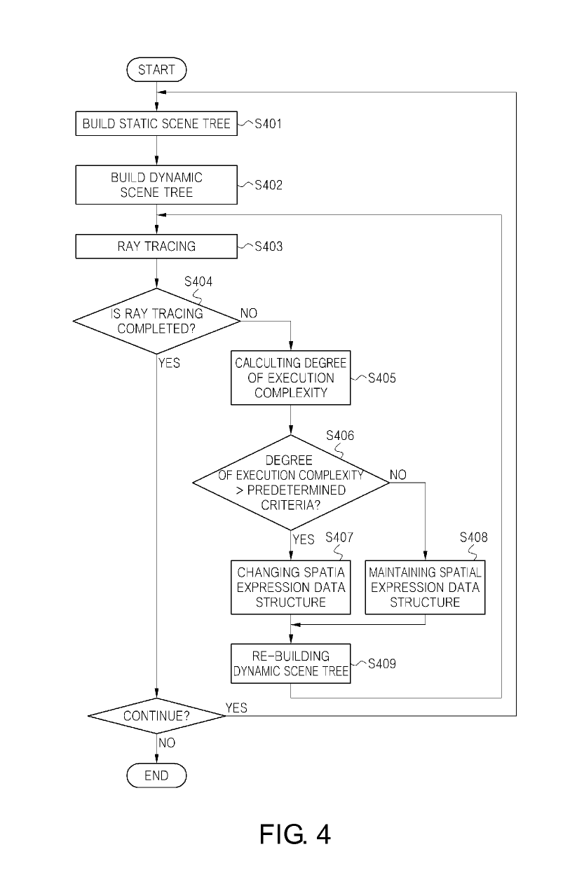

FIG. 4 is a flowchart illustrating an example of a method for processing ray tracing shown in FIG. 3 in detail.

Referring to a configuration of FIG. 2 in FIG. 4, if an application 211 of the CPU 210 is driven, a scene manger 213 may perform a preprocessing procedure to store the static scene, the dynamic scene and the texture map in each area of the system memory 220. In one embodiment, the CPU 210, the system memory 220, and the DRTX 230 may transmit data through a high speed bus.

The DRTX 230 transmits the static scene stored in the system memory 220 to the TBU 130 through the bus interface unit 231 and the TBU 130 builds a tree with respect to the static scene (Step S401). The built static scene tree structure may be stored in the static scene AS structure storage area 242 of the external memory 240 through the AS result buffer 232.

The DRTX 230 may transmit the dynamic scene stored in the system memory 220 to the TBU 130 through the bus interface unit 231 and the TBU 130 build a tree with respect to the dynamic scene (Step S402). The built dynamic scene tree structure may be stored in the dynamic scene AS structure storage area 243 of the external memory 240 through the AS result buffer 232.

The DRTX 230 may store geometric information of each structure in the geometric information storage area 241 while storing the static scene tree structure and the dynamic scene tree structure in the external memory 240. The DRTX 230 may interwork the work memory 234 in a procedure of generating a tree structure of each scene.

The RTU 110 may call the static scene tree structure and the dynamic scene tree structure stored in the external memory 240 through the AS cache 235 to perform the ray tracing (Step S403). For example, the RTU 110 may perform the ray tracing by using the stack memory 238. In one embodiment, the texture map stored in the texture map area 223 of the system memory 220 is stored in a texture map storage area 244 of the external memory 240 and may be transmitted to the RTU 110 through the texture cache 236 if necessary.

When the ray tracing is continuously performed without terminating the three-dimensional application (Step S404), the control unit 120 may calculate the execution complexity of the RTU 110 and TBU 130 (Step S405). In one embodiment, the control unit 120 may calculate the execution complexity based on total of execution time effectively used in the RTU 110 and execution time effectively used in the TRU 130 in reference to performing the ray tracing. In another embodiment, the control unit 120 may monitor load states of the RTU 110 and the TBU 130. In one embodiment, the control unit 120 may confirm frame processing speed of the RTU 110, frame processing speed of the TBU 130, calculate a frame rate per unit time processed by the RTU 111 and a frame rate per unit time processed by the TBU 130 and determine the load states based on the calculated frame rates.

When the execution complexity is larger than the predetermined criterion (Step S406), the control unit 120 may reduce the execution complexity by modifying the spatial expression data structure (Step S407). In one embodiment, when performance of the RTU 110 is higher than performance of the TBU 130, the control unit 120 may determine that a large load is applied to the TBU 130. Thereby, in order to reduce the load of the TBU 130, the control unit 120 may control the TBU 130 to reduce the complexity of the spatial partitioning structure. In the embodiment, the TBU 130 controls to reduce the complexity of the spatial partitioning structure by increasing the maximum primitive number of the leaf nodes or reducing the tree depth.

When the execution complexity is less than or equal to the predetermined criterion (Step S406), the control unit 120 may maintain the execution complexity by maintaining the spatial expression data structure being applied to the RTU 110 and the TBU 130. In one embodiment, when performance of the RTU 110 is lower than performance of the TBU 130, the control unit 120 may determine that a suitable load is applied to the TBU 130 and may control the TBU 130 to increase the complexity of the spatial partitioning structure in order to improve the quality of the AS. In one embodiment, the TBU 130 may control to increase the complexity of the spatial partitioning structure by reducing the maximum primitive number of the leaf nodes or increasing the tree depth.

The TBU 130 may rebuild the dynamic scene tree structure under controlling of the control unit 120 (step S409).

Steps S405 to S409 by the RTU 110, the control unit 120, and the TBU 130 may be repeatedly performed until request of the three-dimensional application or termination of the three-dimensional application is achieved.

The disclosed technology has follow effects. However, since a specific embodiment includes all the following effects or only following effects, right of the disclosure is not limited thereto.

The ray tracing core and the method of processing ray tracing according to the embodiment may improve ray tracing performance. This is because a total execution complexity performing the ray tracing (i.e., the execution time being effectively used) may be reduced by calculating the execution complexity of the RTU 110 and the TRU 130 and selecting the spatial expression data structure applied to the RTU 110 and the TRU 130.

The ray tracing core and the method of processing ray tracing according to the embodiment may improve performance of an apparatus for processing a three-dimensional image. This is because image processing of a rendering scheme according to global illumination may be performed in real time by improving processing speed of ray tracing.

The ray tracing core and the method of processing ray tracing according to the embodiment is applicable to a three-dimensional image processor which has been developed and a three-dimensional image processor which is currently used. This is because a disclosed technology may be performed by replacing only a ray tracing core according to a technology disclosed in an existing device and by updating a program.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A ray tracing core comprising:
a tree build unit (TBU) to build one selected of a plurality of spatial expression data structures expressing a specific space;
a ray tracing unit (RTU) to perform ray tracing based on the selected spatial expression data structure; and
a control unit to select one of a plurality of spatial expression data by calculating an execution complexity of the ray tracing unit and the tree build unit.

2. The ray tracing core of claim 1, the control unit selects another one of the plurality of the spatial expression data structures or monitors a load state of the ray tracing unit when the execution complexity of the ray tracing unit and the tree build unit performed based on the selected spatial expression data structure is larger than a predetermined criterion.

3. The ray tracing core of claim 2, wherein the load state is determined based on a frame rate being processed in the pertinent unit.

4. The ray tracing core of claim 2, the control unit monitors a load state of the ray tracing unit performing the ray tracing based on the selected spatial expression data structure and calculates a complexity of the selected spatial expression data structure to provide the calculated complexity the tree build unit when the control unit monitors the load state of the ray tracing unit.

5. The ray tracing core of claim 4, the tree build unit builds a spatial expression data structure having the calculated f the complexity provided from the control unit.

6. The ray tracing core of claim 1, wherein one of the plurality of the spatial expression data structures is a bounding volume Hierarchy (BVH) or K-dimensional (KD) tree corresponding to a spatial partitioning structure.

7. The ray tracing core of claim 6, wherein the complexity is modified according to either the maximum primitive number of a leaf node with respect to a BVH or KD tree structure and/or a tree depth.

8. The ray tracing core of claim 1, one of the plurality of the spatial expression data structures is a Mean tree corresponding to a number partitioning structure.

9. The ray tracing core of claim 1, further comprising:
a primitive cache to provide a primitive scene to the tree build unit; and
an acceleration structure result buffer to receive a processing result with respect to the primitive scene from the tree build unit.

10. The ray tracing core of claim 1, further comprising:
an acceleration structure cache to provide tree build information with respect to a primitive scene processed by the tree build unit to the ray tracing unit;
a texture cache to provide a texture to the ray tracing unit; and
a color result buffer to receive the tree build information and a processing result with respect to the texture from the ray tracing unit.

11. A method for processing ray tracing by a ray tracing processing apparatus, the method comprising:
(a) building one selected of a plurality of spatial expression data structures expressing a specific space;
(b) performing a ray tracing based on the selected spatial expression data structure; and
(c) selecting one of the plurality of the spatial expression data by calculating an execution complexity with respect to performance of the ray tracing and building the selected spatial expression data structure.

12. The method of claim 11, further comprising:
before the step (a), (x) performing the ray tracing based on one selected of the plurality of the spatial expression data structures;
(y) calculating a complexity of the spatial partitioning structure by monitoring a load state when the ray tracing is performed; and
(z) building the spatial partitioning structure having the calculated complexity.

13. The method of claim 12, wherein the step (y) comprises
(y1) monitoring a load state of a ray tracing unit and a load state of a tree build unit;
(y2) comparing a load of the ray tracing unit with a load of the tree build unit to control the complexity of the spatial partitioning structure; and
(y3) providing the controlled complexity to the tree build unit.

14. The method of claim 13, wherein the step (y1) comprises:
(y1-1) confirming a frame processing speed of the ray tracing unit;
(y1-2) confirming a frame processing speed of the tree build unit;
(y1-3) calculating a frame rate per unit time processed by the ray tracing unit and a frame rate per unit time processed by the tree build unit; and
(y1-4) determining the load state of the ray tracing unit and the load state of the tree build unit based on the calculated frame rate.

15. The method of claim 13, wherein the step (y2) reduces the complexity of the spatial partitioning structure by increasing a maximum primitive number and/or reducing a tree depth when the load of the ray tracing unit is larger than the load of the tree build unit.

16. The method of claim 13, wherein the step (y2) increases the complexity of the spatial partitioning structure by reducing the maximum primitive number and/or increasing the tree depth when the load of the ray tracing unit is less than the load of the tree build unit.

17. A ray tracing processing apparatus comprising:
a central processing unit (CPU) to execute a three-dimensional application;
a system memory to store graphic data information necessary for the three-dimensional application; and
a dynamic ray tracing accelerator (DRTX) to build one selected of a plurality of spatial expression data structures based on the graphic data information, to perform ray tracing based on the selected spatial expression data structure and to change or maintain the spatial expression data structure with respect to the graphic data information by calculating an execution complexity of the ray tracing.

18. The ray tracing processing apparatus of claim 17, further comprising:
an external memory to be operatively associated with the DRTX and to store an acceleration structure of the spatial partitioning structure built according to the graphic data information necessary for the three-dimensional application and to provide the acceleration structure of the spatial partitioning structure to the DRTX.

19. The ray tracing processing apparatus of claim 17, wherein the system memory comprises
a primitive static scene (PSS) area to store static scene information necessary for the three-dimensional application;
a primitive dynamic scene (PDS) area to store dynamic scene information necessary for the three-dimensional application; and
a texture map area to store an MIP-MAP for mapping a texture.

20. The ray tracing processing apparatus of claim 17, wherein the DRTX comprises
a tree build unit (TBU) to build one selected of a plurality of spatial expression data structures expressing a specific space;
a ray tracing unit (RTU) to perform ray tracing with respect to a static scene and/or a dynamic scene based on the selected spatial expression data structure; and
a control unit to select one of the plurality of the spatial expression data by calculating a complexity of the ray tracing unit and the tree build unit.
